(19) United States
(12) Patent Application Publication
(10) Pub. No.: US 2004/0205685 A1
(43) Pub. Date: Oct. 14, 2004

(54) Routing method using a CAD tool

(75) Inventor: Akira Takeda, Chiba (JP)

Correspondence Address: OLIFF & BERRIDGE, PLC, P.O. BOX 19928, ALEXANDRIA, VA, 22320, US

(73) Assignee: KAWASAKI MICROELECTRONICS, INC., Chiba-shi (JP)

(21) Appl. No.: 10/816,944

(22) Filed: Apr. 5, 2004

(30) Foreign Application Priority Data
Apr. 14, 2003 (JP) 2003-109470

(51) Int. Cl. G06F 17/50

(52) U.S. Cl. 716/12; 716/13

(57) ABSTRACT

In a routing method of the present invention, the load of a CAD tool can be reduced and signal lines can be easily shielded by using the CAD tool with the reduced load. By using existing power-supply/ground lines as shield wiring, a specific signal line to be protected against crosstalk is provided while being shielded. A program related to grid definition in the existing CAD tool is changed so as to dispose each grid line between the power-supply and ground lines, and then shield wiring of the specific signal line is performed. Then, another signal line is freely provided in a routing area or routing layer.

### BACKGROUND OF THE INVENTION

1. Field of Invention

The present invention relates to routing methods in general, and in particular to a routing method using a CAD (computer-aided design) tool.

2. Description of Related Art

When integrated circuits such as LSI (large-scale integration) are manufactured, the layout is designed in a work station (hereinafter abbreviated as WS) by using a CAD tool. The CAD tool designs layout and performs routing based on given circuit information, and additionally performs various types of verification according to various manufacturing processes. A reticle is made based on the designed layout data. Then, in the manufacturing process, semiconductor chips are manufactured by using the reticle.

However, when routing between circuits is performed by using a CAD tool, the wiring is done automatically. Therefore, circuits cannot always be efficiently connected, i.e., in the shortest distance, according to the designer's intention. For example, as shown in FIG. 8, a signal line A is disposed along the upper side of a macro X so as to be connected to an I/O. In this case, the length of the line A is longer than it would be in a case where the line A is disposed along the lower side of the macro X. Therefore, the wiring capacitance of the line A increases.

That is, routing is not performed manually, and the signal line is thus provided along the upper side of the macro X in this case. Accordingly, the length of the line is longer than needed, and undesired signal delay exceeding the expected value may thus be created. On the other hand, it is impossible to provide a specific signal line over a long distance in order to adjust the signal delay.

Furthermore, with the recent significant advances in the manufacturing process, the packaging density on a semiconductor chip has been increased and the density of semiconductor devices per unit area has been increased, so that the spaces available to wiring lines have narrowed down. Also, the length of each line for connecting semiconductor devices and the number of lines have been increasing with the increase of the scale of circuit. Accordingly, since the spaces between wiring lines are narrow and neighboring wires extend along each other over a long distance, the problem of crosstalk between lines has become significant.

In order to suppress such crosstalk, in some CAD tools, the spaces between lines is doubled, or a shield is sometimes added based on a design rule (see Patent Document: Japanese Unexamined Patent Application Publication No. 2000-259695).

In the CAD tool disclosed in this Patent Document, however, according to various exemplary embodiments, an analyzing program for analyzing the necessity of adding a shield, and a searching program for searching for a minimum cost so as to automatically perform low cost shielding are required. Furthermore, a database for giving predetermined information to the analyzing program and the searching program is required. Therefore, the load of a CPU in the CAD tool increases, and thus the load of the CAD tool itself increases.

Also, in some CAD tools, the operator can remove two signal lines (lines extending along each other) in which crosstalk is most likely to occur. However, wiring must be newly installed after removing the two lines, and thus operation of the operator generally becomes complicated. In other CAD tools, crosstalk can be prevented by inserting a repeater, or the like, so as to shape waveforms. In that case, however, the number of components increases accordingly, and the size of the semiconductor chip increases as a result.

### SUMMARY OF THE INVENTION

The present invention has been made in view of the above-described problems and shortcomings, and it is an object of the present invention to provide a routing method in which a specific signal line can be provided as the designer intended, even when signal lines are provided by using a CAD tool.

It is another object of the present invention to reduce the load of the CAD tool and to provide a routing method in which signal lines can be easily shielded by using the CAD tool with the reduced load.

In order to achieve these objects, according to an aspect of the present invention, a routing method using a CAD tool includes a step of defining a routing grid a plurality of times; a step of providing a specific signal line in accordance with a first-definition grid; and a step of providing another signal line in accordance with a second-definition grid.

With this routing method, the specific signal line can be provided as the designer intended according to the first-definition grid, and another signal line can be automatically provided according to the second-definition grid. Accordingly, the specific signal line can be provided with the shortest distance, and signal delay can also be adjusted.

According to another aspect of the present invention, a routing method using a CAD tool includes a step of arranging power-supply/ground lines in a mesh pattern in a layout area, every two lines of the power-supply/ground lines having a spacing for a line therebetween; a step of providing a specific signal line between the power-supply/ground lines; and a step of freely providing another signal line between the power-supply/ground lines or in the other part of the layout area.

With this routing method, the specific signal line can be shielded by the existing power-supply/ground lines without providing a shield net, so that a shielding effect against crosstalk can be obtained. Accordingly, a database or the like need not be provided, and thus the load of the CAD tool can be reduced and signal lines can be easily shielded. Other signal lines than the specific signal line can be freely provided between the power-supply/ground lines or in the other part of the wiring area. Therefore, efficient wiring can be realized.

### BRIEF DESCRIPTION OF THE DRAWINGS

FIG. 1 shows a CAD tool according to various exemplary embodiments of the present invention;

FIG. 2 shows a mesh pattern of power-supply/ground lines on a semiconductor chip according to various exemplary embodiment of this invention;

FIG. 3 shows a method for providing a specific signal line according to various exemplary embodiment of this invention;

FIG. 4 shows a method for providing other signal lines according to various exemplary embodiments of this invention;

FIG. 5 shows a portion of shielded signal lines area according to various exemplary embodiments of this invention;

FIG. 6 shows a state where shielded signal line has been done according to various exemplary embodiments of this invention;

FIG. 7 shows a state where the specific signal line and another signal line have been provided according to various exemplary embodiments of this invention; and

FIG. 8 shows a conventional routing method.

### DETAILED DESCRIPTION OF PREFERRED EMBODIMENTS

These and other features and advantages of this invention are described in, or are apparent from, the following detailed description of various exemplary embodiments of the systems and methods according to this invention.

First, a CAD (computer-aided design) tool used in embodiments of the present invention will be briefly explained.

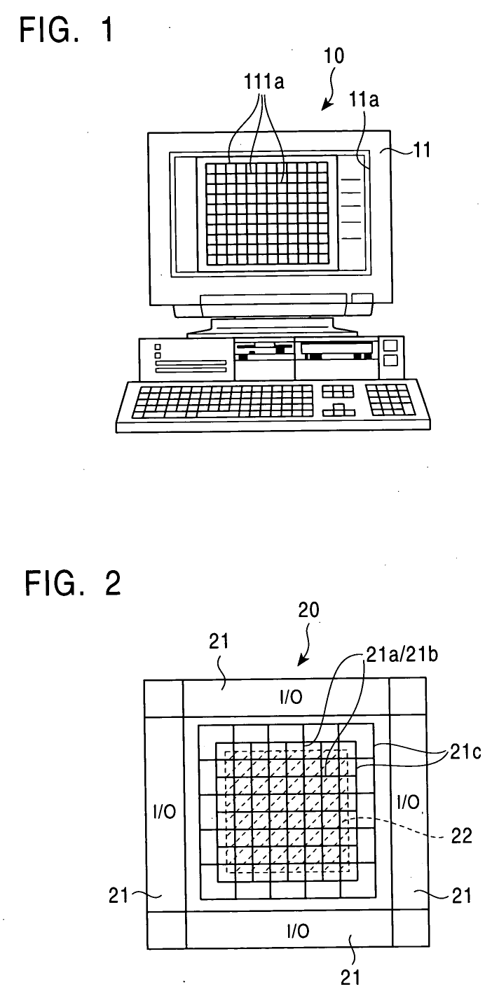

FIG. 1 shows a work station (WS) 10 in which the CAD tool is installed. Layout such as place and routing is performed by using a CAD tool, such as the one described here. When the layout is designed, a grid serving as a minimum unit for performing routing is defined. The layout can be displayed on a screen 11a of a display apparatus 11, and a grid 111a can also be displayed if necessary.

FIG. 2 shows a chip layout 20. A layout area (core portion) 22 for disposing semiconductor devices therein is provided in the center of the chip. Also, an I/O unit 21, which includes input/output terminals for transmitting or receiving signals to and from an external device and a power/ground supply, is provided around the core portion 22.

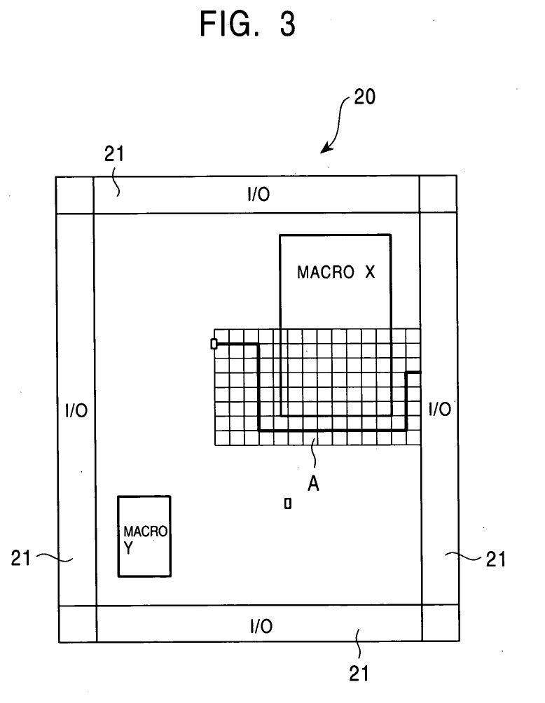

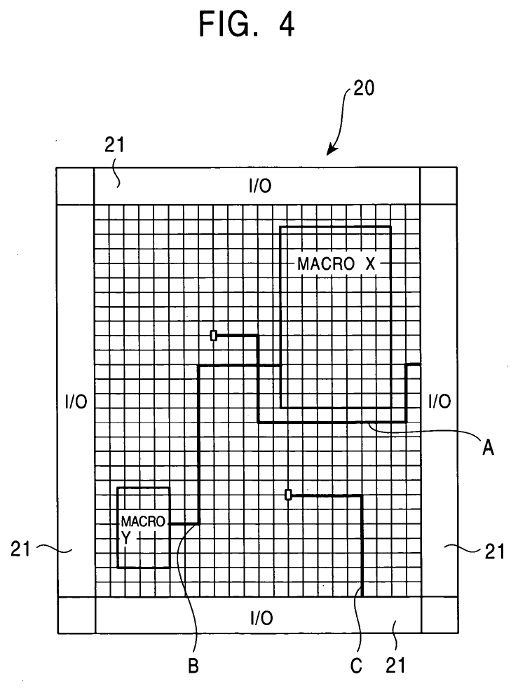

Hereinafter, a routing method according to an exemplary embodiment of the present invention will be described,with reference to FIGS. 3 and 4.

First, a grid is defined at part of the chip such that macro X and macro Y are disposed in the chip. Then, in accordance with the defined grid, a specific signal line A (for example, a signal line to be provided in the shortest distance, or a signal line being intentionally delayed) is provided (FIG. 3). Then, a grid is defined for the entire chip, and signal lines B and C are automatically provided according to the grid (FIG. 4). In this method, according to various exemplary embodiments, the specific signal line can be provided as the designer intended, with the length of the signal line between circuits being set as desired. Accordingly, the delay of a signal can be adjusted.

Next, a routing method according to another embodiment will be described.

As shown in FIG. 2, power-supply and ground lines 21a/21b are arranged in a mesh pattern so as to cover the entire layout area, and are connected to the outermost power-supply/ground ring 21c.

Furthermore, the power-supply/ground ring 21c is connected to the I/O unit 21, so that power from the outside of the chip can be evenly supplied to each semiconductor device in the core portion 22. Routing by the CAD tool is performed inside the I/O unit 21. Since the power-supply/ground lines 21a/21b are arranged substantially over the entire inside area, the wiring route is thus not limited, and a specific signal line can be shielded.

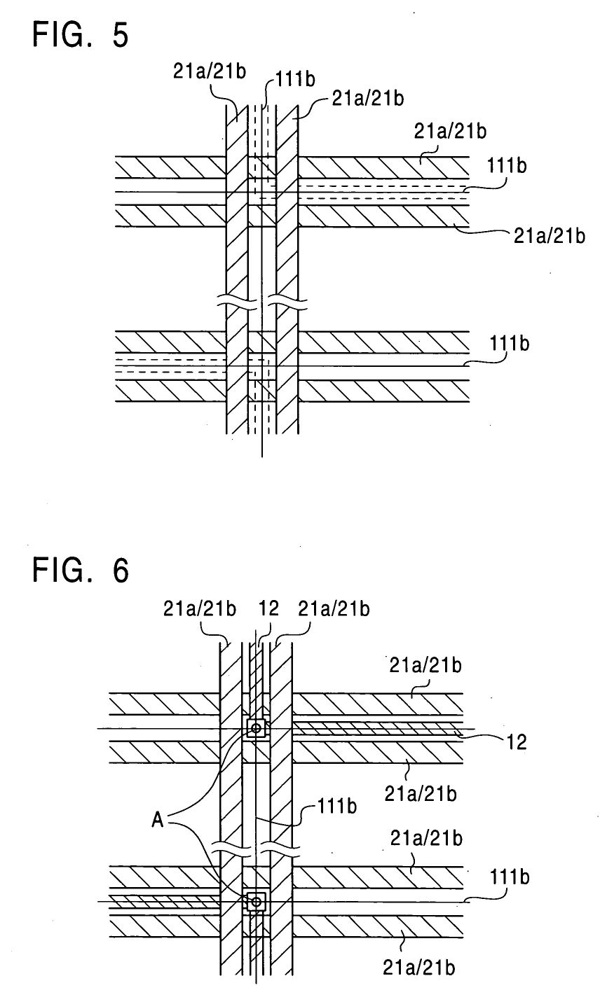

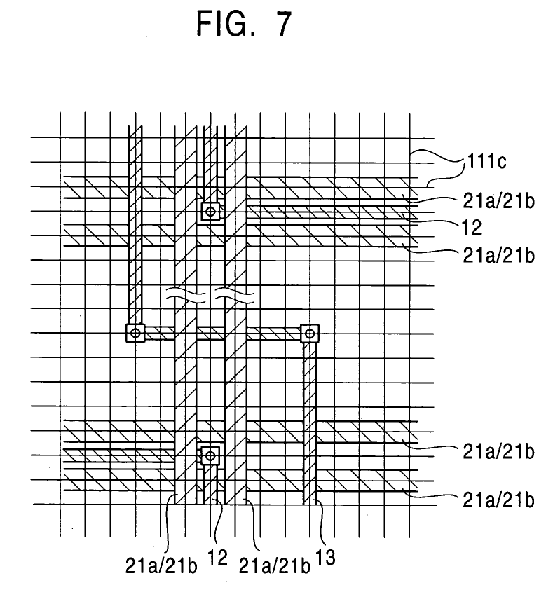

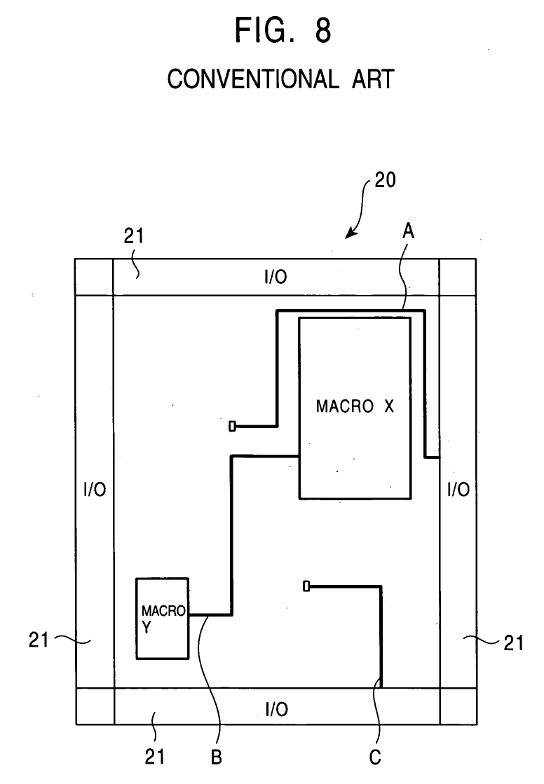

According to various exemplary embodiments, shielding signal lines by using the CAD tool will be described with reference to FIG. 5 and FIG. 6.

In FIGS. 5 and 6, the power-supply/ground lines 21a/21b are arranged over the entire routing area in a multilayered manner (in a mesh pattern). Accordingly, shielded signal lines can be performed by using any part of the mesh consisting of the power-supply/ground lines 21a/21b.

FIG. 5 shows the grid definition and the power-supply/ground lines 21a/21b before a specific signal line is provided while being shielded.

In FIG. 5, a grid is defined so that the grid is positioned in the mesh consisting of the power-supply/ground lines 21a/21b on the semiconductor chip 20, and each grid line 111b is located between the power-supply/ground lines 21a/21b.

Each grid line 111b is in the same layer as and between the power-supply/ground lines 21a/21b. A vertical grid line 111b is located between the power-supply/ground lines 21a/21b in the upper layer, and a horizontal grid line 111b is between the power-supply/ground lines 21a/21b in the lower layer. In this exemplary configuration, routing of a specific signal line 12 can be automatically performed.

FIG. 6 is an expanded view of the screen 11a after the specific signal line 12 has been provided.

As shown on FIG. 6, when the specific signal line 12 is provided, the routing layer is altered when the routing direction is changed at point A, in accordance with the first grid definition. In FIG. 6, the vertical portion of the signal line 12 is shielded by the vertical power-supply/ground lines 21a/21b, and the horizontal portion of the signal line 12 is shielded by the horizontal power-supply/ground lines 21a/21b. A via-hole is provided at point A, where the vertical and horizontal directions of the signal line 12 cross each other. The vertical and horizontal portions of the signal line 12 are connected through the via-hole, so that each portion of the specific signal line 12 is shielded by the power-supply/ground lines 21a/21b in any layer.

With this exemplary method, the specific signal line 12 can be provided by multilayer routing, and each portion of the signal line 12 can be shielded by the respective power-supply/ground lines 21a/21b of the same layer. After performing shield wiring of the signal line 12, the next grid is defined, that is, grid definition is added, so as to provide another signal line 13.

FIG. 7 shows the screen after the next grid has been defined. In FIG. 7, second grid definition has been done, and a grid 111c, serving as an elementary unit, is displayed on the screen of the display apparatus. In this exemplary embodiment, automatic routing is performed in accordance with the grid 111c, so that efficient routing can be performed as described below.

That is, the specific signal line 12, which must be protected against crosstalk, is automatically provided. Then, another signal line 13 is independently provided between the power-supply/ground lines 21a/21b or in any other part of the routing area and of the routing layer. Accordingly, routing can be performed in an area that is shielded. In FIG. 7, vertical portions of the signal lines are in the upper layer and horizontal portions of the signal lines are in the lower layer.

Accordingly, when a signal line other than the specific signal line 12, such as the signal line 13, is provided, the constraint of routing by grid definition, which is required for performing shield wiring, is not imposed, and thus freedom in routing is increased.

As described above, since signal lines can be shielded by using the existing power-supply/ground lines 21a/21b, a database for giving predetermined information to an analyzing program or the like need not be provided. Accordingly, the load to the CAD tool can be reduced. Also, signal lines can be shielded by a simple operation of grid definition.

As described above, according to the routing method of the exemplary embodiment of the present invention, the load of the CAD tool can be reduced, and signal lines can be easily shielded by using the CAD tool with the reduced load.

Furthermore, while this invention has been described in conjunction with exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the invention is intended to embrace all known or later developed alternatives, modifications, variations, improvements, and/or substantial equivalents.

What is claimed is:

1. A routing method using a CAD tool, comprising the steps of:
defining a routing grid a plurality of times;
routing a signal line in accordance with a first-defined grid; and
routing another signal line in accordance with a second-defined grid.

2. The routing method according to claim 1, further comprising the steps of:
arranging power-supply and ground lines in a mesh pattern in a layout area, every two lines of the power-supply and ground lines having a space for a line therebetween;
routing the signal line between the power-supply and ground lines; and
routing the another signal line between the power-supply and ground lines or in another part of the layout area.

3. A routing method using a CAD tool, comprising the steps of:
arranging power-supply and ground lines in a mesh pattern in a layout area, every two lines of the power-supply and ground lines having a space for a line therebetween;
routing a signal line between the power-supply and ground lines; and
routing another signal line between the power-supply and ground lines or in another part of the layout area.

4. A CAD apparatus for designing layout by using the CAD tool according to claim 1.

5. A CAD apparatus for designing layout by using the CAD tool according to claim 2.

6. A CAD apparatus for designing layout by using the CAD tool according to claim 3.
